(19) United States
(12) Patent Application Publication
(10) Pub. No.: US 2017/0126966 A1
(43) Pub. Date: May 4, 2017

(54) PHOTOGRAPHY METHOD USING GAZE DETECTION

(71) Applicant: MEDIATEK INC., Hsin-Chu (TW)

(72) Inventor: Sheng-Hung CHENG, Hsinchu City (TW)

(21) Appl. No.: 15/331,040

(22) Filed: Oct. 21, 2016

Related U.S. Application Data
(60) Provisional application No. 62/247,914, filed on Oct. 29, 2015.

(51) Int. Cl. H04N 5/232; H04N 5/33; H04N 9/09; H04N 5/225; H04N 1/21; G06K 9/00

(52) U.S. Cl. CPC H04N 5/23222; H04N 1/2137; G06K 9/00228; G06K 9/00597; H04N 5/23219; H04N 5/23293; H04N 5/23245; H04N 9/09; H04N 5/2258; H04N 5/33

(57) ABSTRACT

A photography method and an associated camera system provided. The camera system includes a camera and a frame buffer. The method includes the steps of: capturing a plurality of first input images by a first camera when a gaze shooting mode of the camera system is activated; storing the first input images into the frame buffer; performing a face detection on a plurality of detection images associated with the first input images to detect a human face in the detection images; performing a gaze detection on the detection images to detect whether an eye of the detected human face in the detection images is gazing toward the first camera; and selecting one or more of the stored first input images from the frame buffer as output images when it is detected that the eye of the detected human face in the detection images is gazing toward the first camera.

### CROSS REFERENCE TO RELATED APPLICATIONS

This application claims the benefit of U.S. Provisional Application No. 62/247,914 filed on Oct. 29, 2015, the entirety of which is incorporated by reference herein.

### BACKGROUND OF THE INVENTION

Field of the Invention

The present invention relates to a camera device, and, in particular, to photography method and an associated camera system using gaze detection.

Description of the Related Art

In recent years, auto snap in a camera system has been widely used. For example, existing techniques for auto snap may use smile detection, face detection, hand gesture detection, and/or wink detection. However, these techniques cannot ensure that the person being captured in the image is gazing toward the camera lens, resulting in a poor user experience.

Accordingly, there is a demand for a photography method and an associated camera system to solve the aforementioned problem.

### BRIEF SUMMARY OF THE INVENTION

A detailed description is given in the following embodiments with reference to the accompanying drawings.

In an exemplary embodiment, a photography method for use in a camera system is provided. The camera system includes a camera and a frame buffer. The method includes the steps of: capturing a plurality of first input images by a first camera when a gaze shooting mode of the camera system is activated; storing the first input images into the frame buffer; performing a face detection on a plurality of detection images associated with the first input images to detect a human face in the detection images; performing a gaze detection on the detection images to detect whether an eye of the detected human face in the detection images is gazing toward the first camera; and selecting one or more of the stored first input images from the frame buffer as output images when it is detected that the eye of the detected human face in the detection images is gazing toward the first camera.

In another exemplary embodiment, a camera system is provided. The camera system includes: a processor, a frame buffer, and a first camera. The first camera is for capturing a plurality of first input images when a gaze shooting mode of the camera system is activated. The processor stores the first input images into the frame buffer, performs a face detection on a plurality of detection images associated with the first input images to detect a human face in the detection images, and performs a gaze detection on the detection images to detect whether an eye of the detected human face is gazing toward the first camera. The processor selects one or more of the stored first input images from the frame buffer as output images when it is detected that the eye of the detected human face in the detection images is gazing toward the first camera.

### BRIEF DESCRIPTION OF THE DRAWINGS

The present invention can be more fully understood by reading the subsequent detailed description and examples with references made to the accompanying drawings, wherein:

FIG. 1 is a block diagram of a camera system in accordance with an embodiment of the invention;

FIG. 2 is a flow chart of an auto snap method in accordance with an embodiment of the invention;

FIG. 3 is a block diagram of the camera system in accordance with another embodiment of the invention; and

FIG. 4 is a flow chart of a photography method in accordance with another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

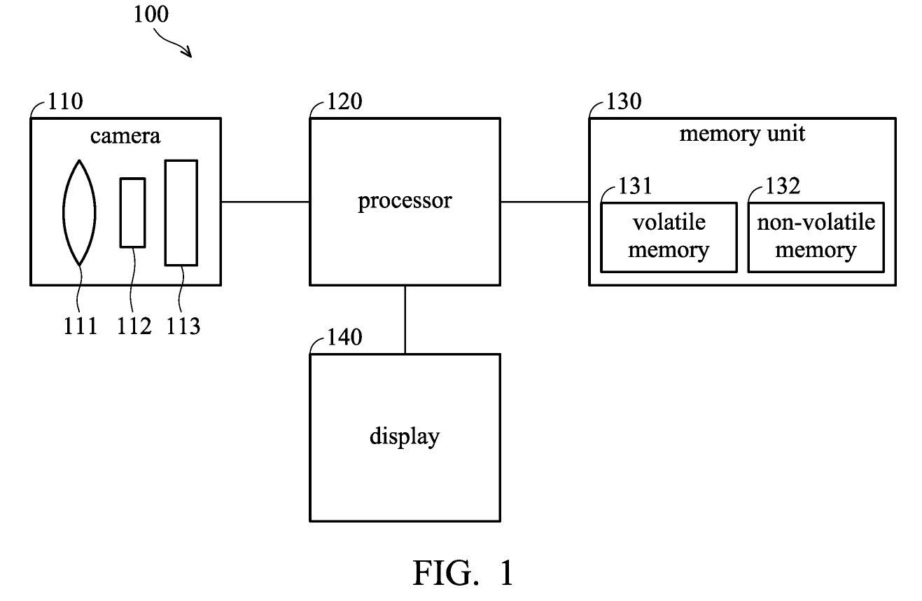

FIG. 1 is a block diagram of a camera system in accordance with an embodiment of the invention. The camera system 100 may be a digital camera (e.g. a still camera, a video camera, a camera phone, or otherwise) including a camera 110, a processor 120, a memory unit 130, and a display 140.

The camera 110 includes a lens 111, a shutter 112, and an image sensor 113. The lens 111 is positioned to focus light reflected from one or more objects in a scene onto the image sensor 113 when the shutter 112 is open for image exposure. The shutter 112 may be implemented mechanically or in circuitry.

The image sensor 113 may include a plurality of photosensitive cells, each of which builds-up or accumulates an electrical charge in response to exposure to light. The accumulated electrical charge for any given pixel is proportional to the intensity and duration of the light exposure. The image sensor 130 may include, but is not limited to, a charge-coupled device (CCD), or a complementary metal oxide semiconductor (CMOS) sensor. The processor 120 may be a central processing unit (CPU), a digital signal processor (DSP), or an image signal processor (ISP), but the invention is not limited thereto.

The memory unit 130 may comprise a volatile memory 131 and a non-volatile memory 132. For example, the volatile memory 131 may be a static random access memory (SRAM), or a dynamic random access memory (DRAM), but the invention is not limited thereto. The non-volatile memory 132 may be a hard disk, a flash memory, etc. The non-volatile memory 132 stores a photography program for performing specific detection tasks on an image captured by the camera 110, such as smile detection, face detection, hand gesture detection, wink detection, and/or gaze detection. The processor 120 loads program codes of the photography program stored in the non-volatile memory 132 into the volatile memory 131, and performs corresponding image processing on the images captured by the camera 110. In addition, the digital images captured by the image sensor 113 are temporarily stored in the volatile memory 131 (i.e. a frame buffer).

The display 140 is provided for presenting the live-view and/or other user interaction. The display 140 may be implemented with various displays, but are not limited to liquid-crystal displays (LCDs), light-emitting diode (LED) displays, plasma displays, and cathode ray tube (CRT) displays.

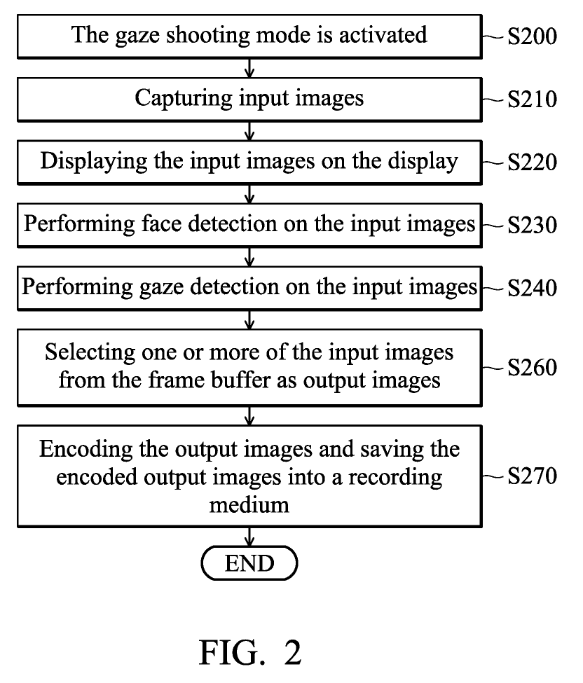

FIG. 2 is a flow chart of a photography method in accordance with an embodiment of the invention. In step S200, the gaze shooting mode of the camera system 100 is activated by the user. In step S210, the camera 110 captures a plurality of input images repeatedly, for example, M (M is a positive integer larger than 1) images are captured consequently. The captured input images are temporarily stored and queued in the frame buffer having a depth of queue M. The depth of queue M of the frame buffer indicates the number of input images stored in the frame buffer.

Each image stored in the frame buffer has an associated time stamp index. For example, given that the depth of queue M is 3, three images each at time N, N−1, and N−2 are stored in the frame buffer. In step S220, the processor 120 displays the input image on the display 140 as a preview image, where the displayed preview image may be the first input image in the frame buffer or displayed all three input images in the frame buffer consequently. In step S230, the processor 120 performs face detection on the input images to detect whether there is a human face in the input images. It should be noted that steps S220 and S230 can be performed simultaneously.

In step S240, the processor 120 further performs gaze detection on the input images which have a human face in them, to determine whether an eye of the human face in the input image are gazing toward the camera 110. In step S260, the processor 120 may select one or more of the input images from the frame buffer. If an eye of the detected human face in the input images is gazing toward the camera, one or more of the input images will be selected from the frame buffer as output images.

In step S270, the output images are encoded (e.g. in JPEG format) and saved into a recording medium (e.g. non-volatile memory 132) of the camera system 100 by the processor 120.

Please notice that, due to the complexity of gaze detection, face detection is performed before gaze detection to decrease the images number in gaze detection step. Only the input images with at least one human face in it are proceed to the gaze detection step, thus the target images number can be reduced. In other word, step S230 is optional in some embodiments.

More specifically, the camera system 100 performs gaze detection to ensure photo quality. In other words, the gaze detection is performed to choose the captured image with at least one eye gazing toward the camera 110.

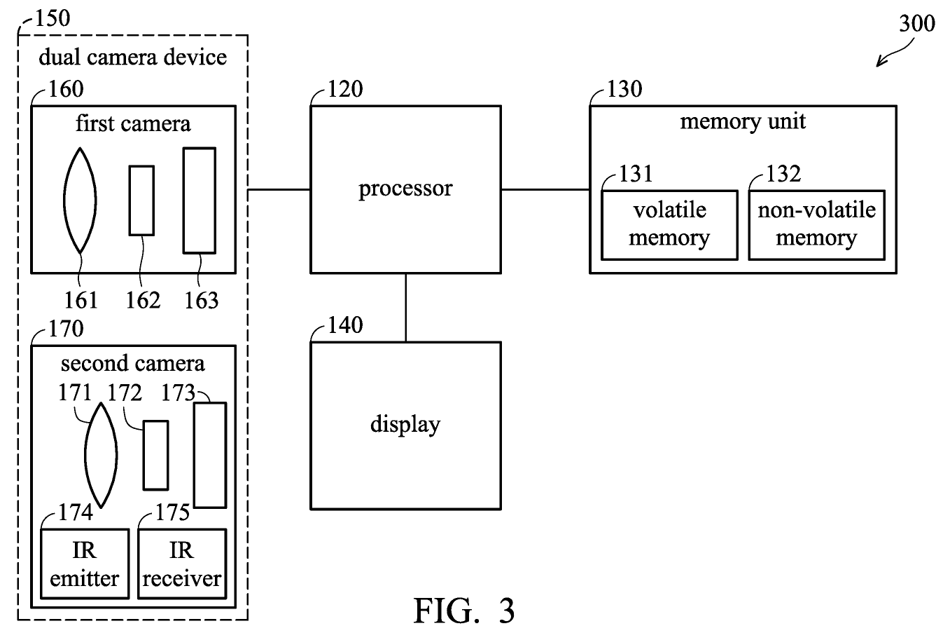

FIG. 3 is a block diagram of the camera system in accordance with another embodiment of the invention. The camera system 300 is similar to the camera system 100 in FIG. 1, and the difference between the camera systems 300 and 100 is that the camera 110 is replaced by a dual camera device 150. The dual camera device 150 includes a first camera 160 and a second camera 170. It should be noted that the first camera 160 and the second camera 170 are integrated into the dual camera device 150 that is disposed on the housing of the camera system 100, so that the first camera 160 and the second camera 170 may face toward the same scene, and capture images simultaneously. The first camera 160 includes a lens 161, a shutter 162, and an image sensor 163, and the second camera 170 includes a lens 171, a shutter 172, an image sensor 173, an infrared emitter 174, and an infrared receiver 175. The embodiments of FIG. 1 can be referred to for the configurations of the lenses and shutters in the first camera 160 and the second camera 170, and the details will be omitted here.

Notably, the image sensor 163 in the first camera 160 is capable of outputting digital YUV image data, or alternatively photosensitive cells in the image sensor 163 are arranged in the “Bayer array” to output RGB image data. The photosensitive cells in the image sensor 173 are also arranged in the “Bayer array” to output RGB image data, and the second camera 170 is capable of outputting RGB-IR image data with the help of infrared emitter 174 and infrared receiver 175. Specifically, the RGB-IR image data includes RGB color images and associated IR images indicating depth information of the RGB color images.

Although automatic face recognition techniques based on the visual spectrum (i.e. color image data) have been widely used, these techniques have difficulties performing consistently under uncontrolled operating environments as the performance is sensitive to variations in illumination conditions. Moreover, the performance degrades significantly when the lighting is dim or when it is not uniformly illuminating the face. Even when a face is well lit, other factors like shadows, glint, and makeup can cause errors in locating the feature points in color face images.

The infrared spectrum of an electromagnetic wave is divided into four bandwidths: near-IR (NIR), short-wave-IR (SWIR), medium-wave-IR (MWIR), and long-wave IR (thermal IR). Face images at long IR represent the heat patterns emitted from the face and thus are relatively independent of ambient illumination. Infrared face images are unique and can be regarded as thermal signature of a human. Thus, infrared face recognition is useful under all lighting conditions including total darkness and also when the subject is wearing a disguise. For example, the processor 120 may extracts the thermal contours and depth information from the IR face image, and then the coordinates of the eyes, nose, and mouth can be identified from the thermal contours. The IR face recognition techniques are well-known to those skilled in the art, and thus the details will be omitted here.

Accordingly, with the help of IR image, it becomes more convenient for the processor 120 to identify the facial features such as eyes, nose, and mouth on the human face and their locations in the current IR image.

In an embodiment, the first images (e.g., RGB images or YUV images) captured by the first camera 160 and the second images (i.e., RGB-IR images) captured by the second camera 170 are sent to different image processing paths. Please note that the first camera 160 and the second camera 170 are synchronized to capture the first images and the second images of the same scene respectively, and thus the second images are associated with the first images. Specifically, the first images captured by the first camera 160 are sent to the image preview path, and the current image is stored and queued in the frame buffer and also displayed as a current preview image on the display 140. Meanwhile, the second images captured by the second camera 170 are sent to the image detection path. In the image detection path, the processor performs face detection and gaze detection on the IR images of the second images to determine whether there is a human face in the current IR image and whether an eye of the human face is gazing toward the second camera 170 or the first camera 160, where the details can be found in the embodiment of FIG. 2. It should be noted that the camera device deployed on the camera system 100 may be a single camera device or a dual camera device, and the processor performs face detection and gaze detection on the “detection images” to determine whether there is a human face in the detection images and whether an eye of the detected human face is gazing toward the single camera device or one of the camera in the dual camera device. For example, the detection images can be the first images captured by the camera 110 in the embodiment of FIG. 1. Alternatively, the detection images can be the IR images of the second images captured by the second camera 170 in the embodiment of FIG. 3.

Specifically, when a dual camera device is deployed on the camera system 100, the IR images captured by the second camera of the dual camera device can be used for the face detection and gaze detection. When it is determined that an eye of the detected human face in the IR images is gazing toward the second camera, the first images captured by the first camera can be selected according to the results of face detection and gaze detection performed on the IR images.

In some embodiments, the image preview path and the image detection path share the same processor 120. In some alternative embodiments, different processors are used each in the image preview path and the image detection path. For purposes of description, the image preview path and the image detection path share the same processor 120 in FIG. 3 and in the following embodiments.

Accordingly, when it is determined that one eye of the human face in the current image is gazing toward the second camera 170 (i.e. may be determined based on either the RGB image or the IR image) in the image detection path, the processor 120 may select one or more of the first images associated with the currently analyzed IR image from the frame buffer. Then, the processor 120 encodes the selected first images and saves the encoded first images into a recording medium (e.g. non-volatile memory 132) of the camera system 100.

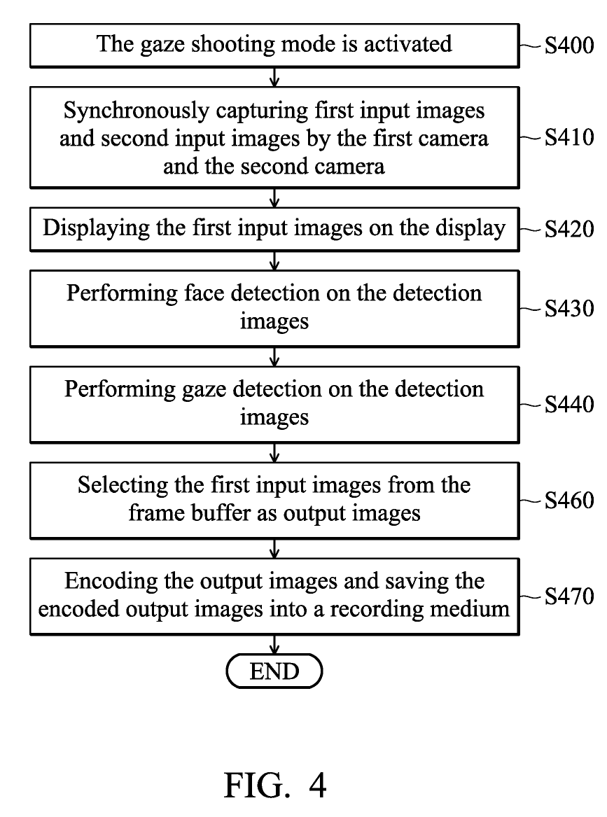

FIG. 4 is a flow chart of a photography method in accordance with another embodiment of the invention. The flow in FIG. 4 is similar to that in FIG. 2, and the flow in FIG. 4 describes a common concept utilized in either FIG. 1 or FIG. 3. For example, in step S410, first input images and second input images are synchronously captured by the first camera and the second camera. For example, the second camera is capable of capturing RGB-IR images, and the second input images includes RGB images and associated IR images that indicate depth information of the RGB images.

In step S420, the first input images are displayed on the display of the camera system.

In step S430, face detection is performed on the “detection images” to determine whether a human face is in the detection images. For example, the detection images can be the first input images captured by the first camera, i.e. camera 110 or the first camera 160. Alternatively, the detection images can be the IR images in the second input images. With the help of IR images, it is easier to recognize the human face in the IR images and associated RGB images.

In step S440, gaze detection is performed on the detection images to determine whether an eye of the detected human face is gazing toward the first camera (or the second camera). In some embodiments, the detection images can still be the IR images in the second input images. In some alternative embodiments, the gaze detection can be performed on the RGB images of the second input images.

In step S460, the processor 120 may select one or more of the first input images from the frame buffer. For example, if an eye of the detected human face in the detection images is gazing toward the first camera (or the second camera), one or more of the first input images will be selected from the frame buffer as output images.

In step S470, the output images are encoded (e.g. in JPEG format) and saved into a recording medium (e.g. non-volatile memory 132) of the camera system 100 by the processor 120.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A photography method for use in a camera system, wherein the camera system comprises a first camera, and a frame buffer, the method comprising:
capturing a plurality of first input images by a first camera when a gaze shooting mode of the camera system is activated;
storing the first input images into the frame buffer;
performing a face detection on a plurality of detection images associated with the first input images to detect a human face in the detection images;
performing a gaze detection on the detection images to detect whether an eye of the detected human face in the detection images is gazing toward the first camera; and
selecting one or more of the stored first input images from the frame buffer as output images when it is detected that the eye of the detected human face in the detection images is gazing toward the first camera.

2. The photography method as claimed in claim 1, wherein the detection images are the first input images, and the first input images comprise RGB images or YUV images.

3. The photography method as claimed in claim 1, further comprising:
displaying the first input images on a display of the camera.

4. The photography method as claimed in claim 1, wherein the frame buffer stores the first input images that comprise a current image and at least one previous image, and the output images are selected from the current image and the at least one previous image.

5. The photography method as claimed in claim 4, wherein each of the current image and the at least one previous image is assigned with an individual time stamp index, and the method further comprises:
utilizing the individual time stamp index to identify the selected output images.

6. The photography method as claimed in claim 1, further comprising:
encoding the output images; and
storing the encoded output images into a recording medium of the camera system.

7. The photography method as claimed in claim 1, further comprising:
capturing a plurality of second input images by a second camera of the camera system in synchronization with the first camera when the gaze shooting mode of the camera system is activated;
wherein the second input images comprise RGB images and associated infrared (IR) images, and the detection images are the IR images.

8. The photography method as claimed in claim 7, wherein the IR images in the second input images indicate depth information of the RGB images of the second input images.

9. A camera system, comprising:
a processor;
a frame buffer;
a first camera, for capturing a plurality of first input images when a gaze shooting mode of the camera system is activated,
wherein the processor stores the first input images into the frame buffer, performs a face detection on a plurality of detection images associated with the first input images to detect a human face in the detection images, and performs a gaze detection on the detection images to detect whether an eye of the detected human face is gazing toward the first camera,
wherein the processor selects one or more of the stored first input images from the frame buffer as output images when it is detected that the eye of the detected human face in the detection images is gazing toward the first camera.

10. The camera system as claimed in claim 9, wherein the detection images are the first input images, and the first input images comprise RGB images or YUV images.

11. The camera system as claimed in claim 9, wherein the processor displays the first input images on a display of the camera system.

12. The camera system as claimed in claim 9, wherein the frame buffer stores the first input images that comprise a current image and at least one previous image, and the one or more output images are selected from one of the current image and the at least one previous image.

13. The camera system as claimed in claim 12, wherein each of the current image and the at least one previous image is assigned with an individual time stamp index, and the processor further identifying the selected image data from the frame buffer as the output image utilizing the individual time stamp index.

14. The camera system as claimed in claim 9, wherein the processor further encodes the output images, and stores the encoded output images into a recording medium of the camera system.

15. The camera system as claimed in claim 9, further comprising:
a second camera for capturing a plurality of second input images in synchronization with the first camera when the gaze shooting mode of the camera system is activated;
wherein the second input images comprise RGB images and associated infrared (IR) images, and the detection images are the IR images.

16. The camera system as claimed in claim 15, wherein the IR images in the second input images indicate depth information of the RGB images of the second input images.
